(19) United States
(12) Patent Application Publication
(10) Pub. No.: US 2023/0368237 A1
(43) Pub. Date: Nov. 16, 2023

(54) SYSTEM AND METHOD OF REWARDING RECIPIENTS FOR RECEIVING DISTRIBUTED INFORMATION

(71) Applicant: Jasmin ALEKNAVICIUS, Bonville (AU)

(72) Inventor: Jasmin ALEKNAVICIUS, Bonville (AU)

(21) Appl. No.: 18/024,956

(22) PCT Filed: Sep. 7, 2021
(86) PCT No.: PCT/AU2021/051036

§ 371 Date: Mar. 6, 2023

(30) Foreign Application Priority Data
Sep. 7, 2020 (AU) 2020903192

(51) Int. Cl. G06Q 30/0217

(52) U.S. Cl. CPC G06Q 30/0217

(57) ABSTRACT

A method of rewarding recipients for the resources devoted to reviewing and/or responding to a requestor's data, the method comprising: a database administrator administering a database pertaining to potential recipients including data relating to identification details and profiles of the potential recipients, separating identification details from the potential recipients' profile data, enabling access to potential recipients' profile data in accordance with a request thereby enabling the requestor to analyse the profile data of potential recipients without access to corresponding identification details of the potential recipients, receiving a request to transmit the requestor's data to potential recipients relevant to a data query resulting from analysis of the profile data; and the database administrator transmitting the requestor's data to the selected recipients who satisfy the analysis profile on behalf of the requestor, the requestor's data requiring a response from selected recipients whereby those selected recipients receive a reward for providing the response.

### FIELD OF THE INVENTION

The present invention provides a system and method that rewards recipients for receiving information or requests and is particularly suited to circumstances in which recipients receive information in the form of advertisements for goods and/or services whereby the provider of those goods and/or services seeks to distribute information to recipients in an attempt to obtain interest, purchase, response and/or action from those recipients. In other circumstances, the present invention is applicable where a response from a recipient is sought for the purpose of completing a questionnaire, effecting one or more actions, or otherwise obtaining information relevant to the recipient. In addition to rewarding recipients who devote time and/or effort to provide information or a response as requested, or perform an action, the system and method of the present invention also assists to protect the identification details of recipients who seek to be rewarded according to the present system and method.

### BACKGROUND OF THE INVENTION

As individuals and consumers have increasingly embraced communicating and conducting transactions with each other in an on-line form, companies and organisations seeking to increase their sales revenue in relation to the goods and/or services they provide have also increasingly embraced on-line communications as a means to identify potential customers and offer their goods and/or services to those potential customers.

Accordingly, it is now common for many consumers to conduct most of their transactions on-line such as attending to their banking requirements and ordering the delivery of goods and/or services such as grocery items, clothing, books and gifts. Each time a consumer engages with an on-line trading entity, identification details of the consumer are generally obtained by the on-line trading entity for the purpose of using that identification information in the future to either forward additional information to the consumer in the form of offers or seek to obtain additional information from the consumer to determine the potential to sell other goods and/or services to that consumer.

In some instances, trading entities who gain identification details of consumers interested in their goods and/or services may provide those identification details to other trading entities to obtain their own reward associated with gathering and collecting identification details of individuals and providing that information to another trading entity.

Of course, whilst trading entities may obtain great benefit from gathering, collecting and using the identification details of consumers, the consumers themselves remain unrewarded and may receive many additional requests to review information, such as advertisements, which requires time and effort on the part of the consumer to receive, review the information and potentially reply to the requesting entity regarding the information provided to the consumer. This problem is exacerbated in many instances where consumers may automatically be included in a marketing distribution list of the trading entity once they provide their identification details during a purchase transaction. The gathering of consumer information and storage of same in a distribution list is often suggested to consumers on the basis that they are joining a “mailing list” to receive future offers regarding goods and/or services from the entity from whom they are making a purchase.

Many also engage with social media service providers which involves providing substantial detail regarding the individual, including, identification details and other information which may assist others to deduce information about the individual regarding their preferences in respect of a range of issues. For example, depending upon the information provided by an individual to a social media service and/or the other individuals with whom they engage through social media services, it may be possible to deduce the individuals political preferences and/or purchasing preferences with respect to a range of good and/or services.

In view of the substantial amount of information that is now available on-line regarding individuals including their contact details, it is now possible to compile large databases of information pertaining to individuals including profiles of those individuals according to deductions and/or on-line information directly indicating an individual's preferences and views in relation to a large number of issues. For this reason, individuals regularly find themselves devoting a substantial amount of their time reviewing information provided to them in the form of advertisements, offers and/or questionnaires that attempt to determine further information regarding the individual or obtain sufficient interest to engage the individual in a transaction.

Whilst individuals clearly prefer to remain engaged on-line, there is an increasing awareness amongst individuals that they are devoting significant amounts of time and effort providing information about themselves and/or people known to themselves, or responding to information provided to them electronically, for the benefit of those collecting and compiling the information.

The inefficiency of mass marketing or mass information campaigns is well known since they generally involve providing information to potential consumers who have no interest in the information. In some instances, the inappropriate provision of information to individuals may result in reputational damage on the part of the entity transmitting the information.

The problem associated with individuals becoming inundated with requests for information is also a problem for entities seeking to sell their goods and/or services and/or obtain information relevant to a particular issue from a number of individuals. As individuals are inclined to dis-engage from information requests received on-line, the problem for those entities seeking to retain engagement with individuals is exacerbated.

Whilst it is recognised that targeted marketing campaigns to individuals with a profile indicating that they would be the most receptive to such a campaign, in the event that individuals increasingly dis-engage from requests for information and/or the time required of an individual to review a sales offer or request for confirmation regarding interest in relation to a subject, it becomes necessary for entities seeking to execute a marketing campaign to consider mass marketing campaigns to improve their prospects of receiving responses from interested individuals.

Accordingly, there is a need for a system and method to enable individuals to be rewarded for the time and effort devoted by the individual to review information provided by another entity such that the individual is motivated to devote the required time and effort. Accordingly, the system and method of the present invention seeks to ameliorate one or more of the problems described above and/or at least provide an alternative to present arrangements.

### SUMMARY OF THE INVENTION

In one aspect, the present invention provides a method of rewarding recipients for the resources devoted to reviewing and/or responding to a requestor's data, the method including the steps of a database administrator administering a database of data pertaining to potential recipients including data relating to identification details and one or more profiles of the potential recipients, the database administrator separating the data relating to identification details from the profile data of the potential recipients thereby generating anonymised profile data for each potential recipient, separate from identification details and preventing potential recipients accessing the anonymised profile data, enabling access to profile data of potential recipients in accordance with a request thereby enabling the requestor to analyse the profile data of potential recipients but without access to any identification details of corresponding potential recipients, receiving a request to transmit the requestor's data to one or more potential recipients relevant to a data query resulting from an analysis of the profile data, and the database administrator transmitting the requestor's data to recipients who satisfy the analysis profile for and on behalf of the requestor, the requestor's data requiring a response from recipients satisfying the analysis profile whereby recipients providing a response receive a reward, the database administrator providing responses to the requestor without provision of any identification details regarding the recipients.

A potential recipient may be either an individual or an organisation such as a company or other type of organisation such as a collective or non-profit association. Responses include a range of conduct such as viewing an article or advertisement but may also include more significant actions such as viewing a feature length movie or performing an action.

The database administrator acts as an intermediary between the potential recipients whose identification and profile data is stored separately in the database and external entitles and prevents the association between a potential recipient's identification details and their profile data from becoming publically available to outside entities. In this instance, the database administrator effectively becomes a trusted intermediary enabling external entities to obtain the benefit of accessing the profile data of a large number of potential recipients that meets a requestor's specific requirements yet at the same time preventing those external entities from identifying the potential recipients with respect to whom the profile data is reviewed and/or analysed.

A response includes a range of possibilities such as providing information, completing a questionnaire or possibly performing one or more actions sought by the requestor. Of course, a response includes a combination of one or more of the possibilities available.

In an embodiment, the database administrator separates responses provided by selected recipients from the identification details of those recipients such that providing the responses to the requestor does not provide any identification details regarding those recipients who have provided the response. In this embodiment, the database administrator may readily identify those recipients who have provided a response or performed an action, according to the requestor's information and is therefore able to direct any acknowledgement or reward to those recipients who have provided a response or performed the requested action. The external entities requesting a response from individuals may include organisations such as companies or associations (such as non-profit groups), or may even include individual persons or a collective of persons. The database administrator in their role as trusted intermediary may control the activities and/or actions of requestors such as limiting requests of individuals.

In an embodiment, the database administrator may provide profile data of all the potential recipients for whom details are recorded in the database to an external entity, such as an advertising agency or a data analysis agent, who seeks to analyse the profile data of all the potential recipients collectively to determine the merits of either requesting information from the recipients or transmitting offers to those recipients for the purpose of obtaining interest in goods and/or services. The provision of profile data may be on-going such that those seeking to analyse such data has continuous access to the data. Conducting such an analysis may determine the commercial merit of initiating a campaign to transmit offers to potential recipients or seek information from potential recipients for whom details are stored in the database. This clearly provides an advantage to external agencies who seek to identify whether potential recipients fall within their “target market group” and although the external agency is not provided with the direct identification details of potential recipients, by analysing the recipients profile data, they can determine whether a marketing campaign is warranted.

In another embodiment, the external agency may be a market research organisation seeking to understand the preference profile of consumers who purchase a particular good and/or service. In many instances, market research is conducted to better understand the preferences of consumers who already fall into a group of interest to the market research organisation.

According to the invention, once an external agency has analysed the profile data of potential recipients and determined that a campaign to offer goods and/or services to potential recipients, or seek information from those potential recipients, in return for a reward, the agency who conducted the profile analysis provides the details of that analysis to the database administrator thereby enabling the database administrator to execute the same analysis. Of course, the external agency conducts the analysis without the benefit of identification details in relation to those potential recipients who have a relevant profile whereas once the same analysis is conducted by the database administrator, the administrator has the benefit of obtaining the identification details of those potential recipients relevant to that particular analysis. This particular arrangement also has the benefit of obtaining the most up to date details regarding potential recipients relevant to the analysis that seeks to identify those potential recipients with a “profile of interest”.

In various circumstances, it is expected that an agency conducting an analysis of profile data may complete the analysis and determine that an information campaign is warranted although the database administrator may not receive instructions and/or payment from the agency until some time has passed. For example, the lapse of time between an agency conducting a profile analysis and instructing a database administrator to perform the same analysis to identify the relevant recipients may be a period of one or two weeks or possibly one or two months. In that time, the database may have attracted many more potential recipients to provide their details and hence, the database administrator repeating the analysis to identify relevant recipients will utilise the most up to date information regarding the potential recipients who have provided their details to the database administrator.

In another embodiment, upon being identified as a relevant recipient according to an analysis of profile data, selected recipients are provided with a requestor's information, such as an advertisement or a questionnaire for completion or a requested action that requires completion. Upon reviewing the advertisement and/or completing the questionnaire/action, the selected recipient provides their response to the database administrator who may forward same to the external agent without the identification details of the selected recipient. In these circumstances, the database administrator may clearly identify those selected recipients who have provided a response to the requestor's information and may allocate a reward to those recipients.

In embodiments, the reward may include cash payments, reward points that have value according to the database administrator's services, reward points that have value with entities other than the database administrator, and/or a discount that may be applied to the purchase of goods and/or services at some time in the future from one or more entities.

In one embodiment, the reward offered to selected recipients responding to a requestor's information varies according to the time in which the recipient provides a response to the requestor's information, or the time and effort associated with responding to a requestor's request. For example, in the event a selected recipient provides a prompt response, the reward may have a greater value as compared with a response that is provided two or three days later or potentially two or three weeks after the selected recipient receives the requestor's information. In this embodiment, selected recipients receive a greater reward for a prompt response as compared with a delayed response or a greater reward according to the time/effort involved. More usually, rewards are provided according to the perceived effort on the part of the selected recipient providing the response. In this regard, the greater the effort required, the greater the reward.

In some embodiments, the reward selected is relevant to the target demographic of interest to the requestor which provides a specific, and potentially greater, motivation to selected recipients with a matching profile to respond to the request by providing the information sought, or performing the action required.

In yet another embodiment, in the event a selected recipient is interested in an advertisement for goods and/or services and prefers to purchase those goods and/or services, individual recipients may elect to act upon the offer separately and externally to the database administrator and when electing to purchase goods and/or services, it may remain unknown to the provider of the goods and/or services whether particular selected recipients received the offer through the database administrator's services or through another mechanism. However, in a preferred embodiment, a consumer purchase arising from an advertisement or offer provided to selected recipients are always identified to the provider of the goods and/or services thereby enabling the provider to determine the efficacy of the advertisement/offer and the value of the database administrator's services. In one embodiment, in instances where a response to an offer of goods or services requires the personal details of a selected recipient, the recipient authorises the provision of those details by the database administrator thereby enabling the database administrator to retain the position of never releasing recipient details without authorisation. In another embodiment, the system includes cookies functionality that enables the searching history of a user to be tracked, thereby facilitating retailers to ascertain sales arising from their advertisements.

In another aspect, the present invention provides a system that rewards recipients for the resources devoted to reviewing and/or responding to a requestor's data, the system including one or more databases pertaining to potential recipients including data relating to identification details and one or more profiles of the potential recipients, and one or more processors, communicatively coupled to the one or more databases, that are operable to enable a database administrator to administer the one or more databases, and separate the data relating to identification details from the profile data of the potential recipients thereby generating anonymised profile data for each potential recipient separate from identification details and preventing potential recipients accessing the anonymised profile data, enable access to profile data of potential recipients in accordance with a request thereby enabling the requestor to analyse the profile data but without access to corresponding identification details of potential recipients, receive a request to transmit the requestor's data to one or more of the potential recipients relevant to a data query resulting from an analysis of the profile data, and the one or more processors further operable to enable the database administrator to transmit the requestor's data to recipients who satisfy the requestor's profile analysis for and on behalf of the requestor, the requestor's data requiring a response from the recipients satisfying the analysis profile whereby recipients providing a response receive a reward, the database administrator causing the responses to be provided to the requestor without provision of identification details regarding recipients.

In another aspect, the present invention provides a computer-readable medium storing computer instruction code to reward recipients for the resources devoted to reviewing and/or responding a requestor's data, the instructions including one or more instructions that, when executed by one or more processors, cause the one or more processors to enable a database administrator to administer a database of data pertaining to potential recipients including data relating to identification details and one or more profiles of the potential recipients, enable the database administrator to separate the data relating to identification details of the potential recipients from the profile data of those recipients thereby generating anonymised profile data for each potential recipient separate from identification details and preventing potential recipients accessing the anonymised profile data, enable access to profile data of recipients in accordance with a request thereby enabling the requestor to analyse the profile data of potential recipients but without access to corresponding identification details of the recipients, receive a request to transmit the requestor's data to the one or more potential recipients relevant to a data query resulting from an analysis of the profile data, and enable the database administrator to transmit the requestor's data to recipients who satisfy the requestor's profile analysis for and on behalf of the requestor, the requestor's data requiring a response from the recipients satisfying the analysis profile whereby those recipients providing a response receive a reward for providing the response, the database administrator providing recipient responses to the requestor without provision of any identification details regarding the recipients.

### BRIEF DESCRIPTION OF THE DRAWINGS

Features of the present disclosure are illustrated by way of example and not limited in the following figure(s), in which like numerals indicate like elements, in respect of which:

FIG. 1 illustrates an exemplary computer-implemented system and method of rewarding recipients for receiving distributed information in accordance with the present invention;

FIG. 2 illustrates an exemplary flow diagram associated with the server component of the system illustrated in FIG. 1;

FIG. 3 illustrates an exemplary flow diagram of a process that enables a user to download and install a software application and subsequently login, or register, to use the software application for interacting with the system illustrated in FIG. 1;

FIG. 4 illustrates an exemplary flow diagram of a process that enables the user to provide detailed information about themselves and to link their social media account(s);

FIG. 5 illustrates an exemplary flow diagram associated with the server component of FIG. 2 interfacing with a range of social media platforms;

FIG. 6 illustrates an exemplary flow diagram of a process that enables advertisers to interact with and use the system illustrated in FIG. 1 to advertise directly to customers and receive feedback;

FIG. 7 illustrates an exemplary flow diagram of a process that enables the user to receive targeted advertising and engage with content to earn credits;

FIG. 8 illustrates an exemplary flow diagram associated with the server components illustrated in FIG. 2 using a browser plug-in/extension which represents an alternate way that the user can receive targeted advertising and engage with advertisers to earn credits; and

FIG. 9 illustrates an exemplary flow diagram of a process that enables the user to view their credits and utilise same to purchase goods and/or services, and pool accounts with other users.

### DETAILED DESCRIPTION OF EMBODIMENT(S) OF THE INVENTION

The present invention relates to at least a computer-implemented system and method of rewarding users (also referred to herein as “recipients”) (170) for the resources they devote to reviewing and/or responding to information (also referred to herein as “content”) (60) provided by a requestor (such as an advertiser organisation (270) or similar).

In particular, a database administrator (not shown) administers one or more databases (e.g. 30, 80) of data pertaining to potential recipients (170) including data relating to identification details and one or more profiles of the potential recipients, wherein the identification details and profile data associated with each potential recipient is separated by the administrator in order to enable access solely to profile data, e.g. in response to a requestor request to analyse user data. It is to be understood that the database administrator may be an individual, an organisation, or one or more computing components capable of performing the steps described herein as steps that are carried out by the database administrator.

Based upon an analysis of the profile data, the requestor (50) then requests transmittal of content to one or more selected recipients (170), the database administrator tasked with transmitting such content for and on behalf of the requestor (50). The requestor's data (60) requires a review or response from the one or more selected recipients (170) whereby those selected recipients providing a review or response receive a reward for providing same.

In a practical application, the abovementioned system and method, also referred to herein as a “platform”, is utilised in circumstances where an advertiser organisation (270) or the like prefers to advertise directly to customers (170) and receive feedback in various forms, wherein the selected recipients (170) are given a reward (e.g. fees or credit) which they can subsequently utilise, e.g., to purchase products and/or services. Since the advertiser organisation (270) is not provided any access to identification details associated with the recipients (170), they are prevented from directly contacting any recipients.

A recipient (170) may be an individual, such as user (170), or an organisation such as a company or any other type of organisation such as a collective or non-profit association. It will also become apparent that a “response” from a recipient (170), once selected, can include a range of conduct such as viewing an article or advertisement, but may also include more significant actions such as sharing content, interacting with content (e.g. viewing a feature length movie) or performing any other action.

The steps described above may be carried out using a central server (20) which maintains one or more processors and databases for performing the one or more actions described, and the server (20) may be configured for communication with one or more user devices (e.g. user device (180)) upon which a dedicated software application (190, 210) is operable. As mentioned above, the database administrator may be a natural person, or alternatively, the steps carried out by the database administrator could be automated.

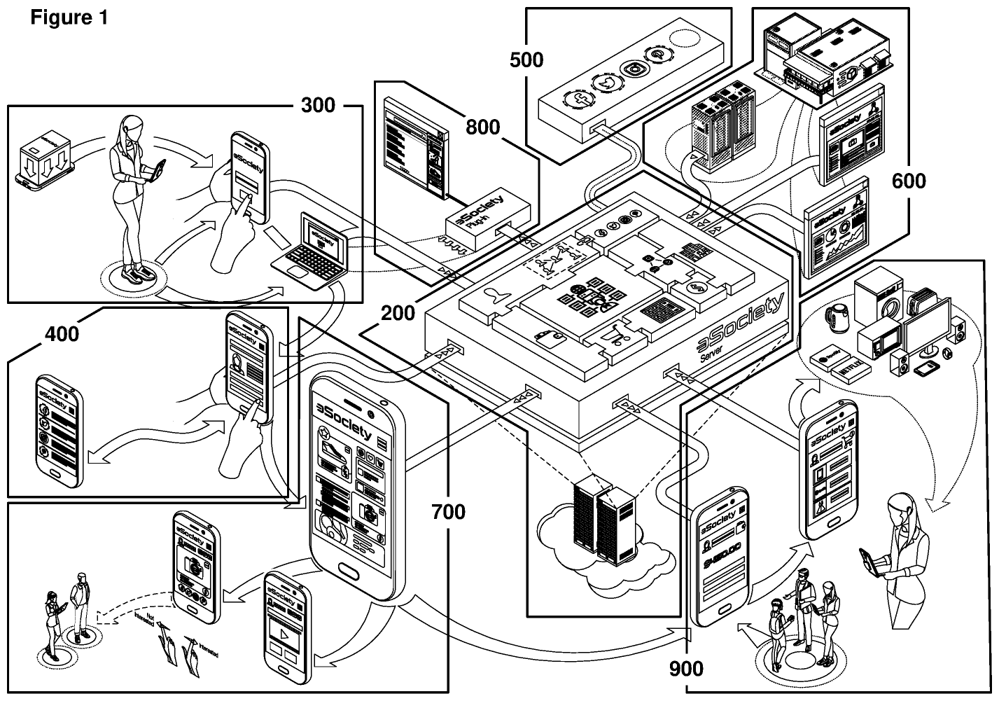

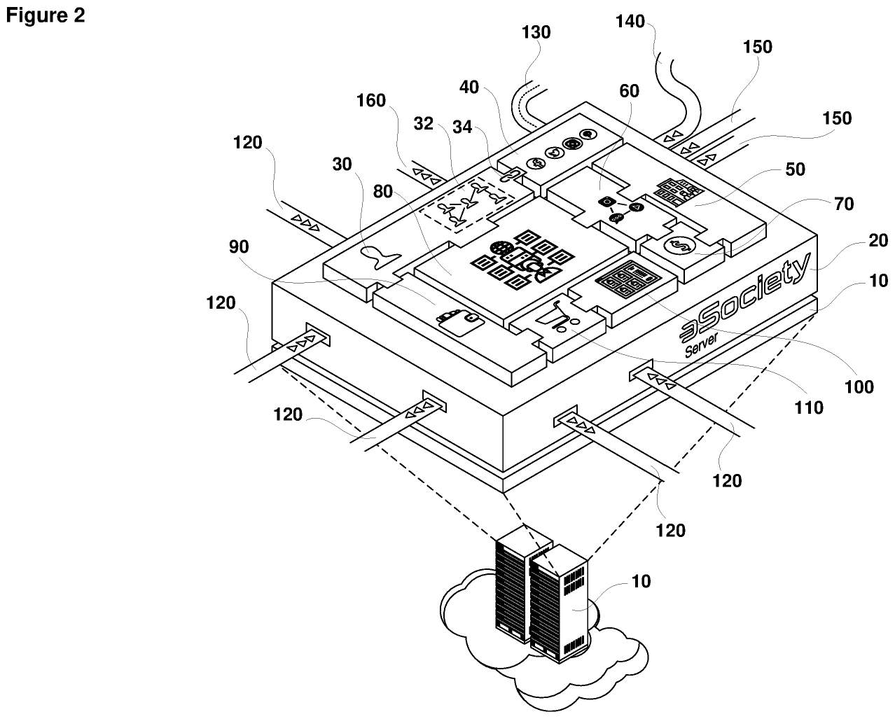

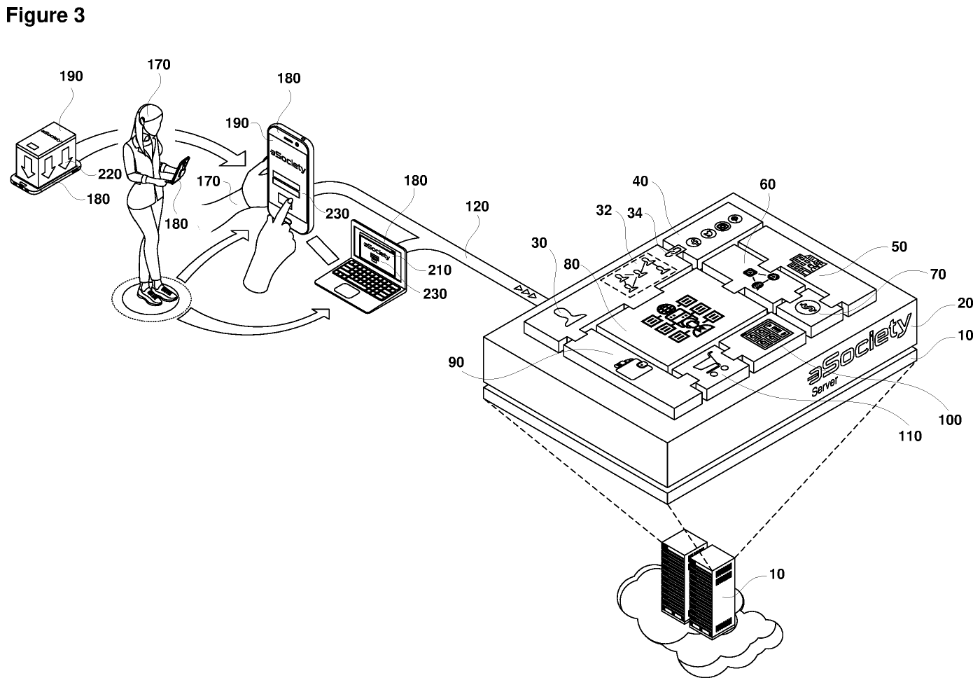

FIG. 1 is divided into segments which are further expanded in the subsequent FIGS. 2 to 9. In particular, segment 200 of FIG. 1 shows the server component (20) with which the software application (190, 210) operating on a user device (180) is configured to communicate. This is expanded in FIGS. 2 and 3, and the skilled person will appreciate that the software application (190, 210) may operate on a portable device such as a mobile phone (180), or on a computer such as a desktop computer or laptop (180) with which interaction is made possible by use of a web browser. FIG. 3 shows examples of both a mobile phone and web browser in use, with applications (190) and (210) operating respectively. As an alternative or in addition to steps performed by the user devices (180), steps may also be performed by one or more processors associated with the server (20) as described further herein. According to an embodiment, the server (20) may be programmed to provide the functions that are preferably provided by the server rather than locally on the user devices.

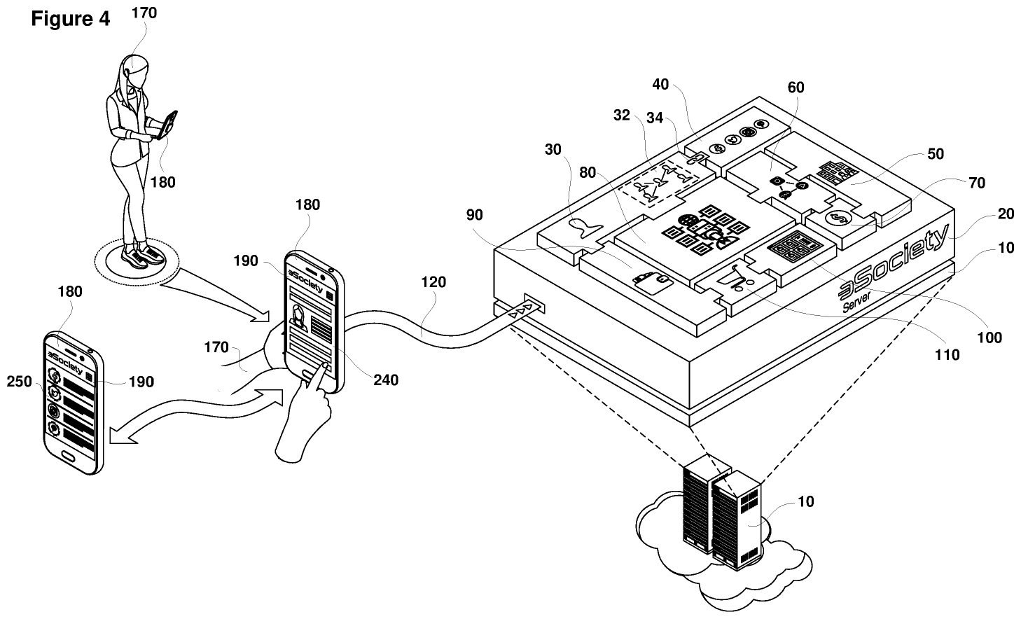

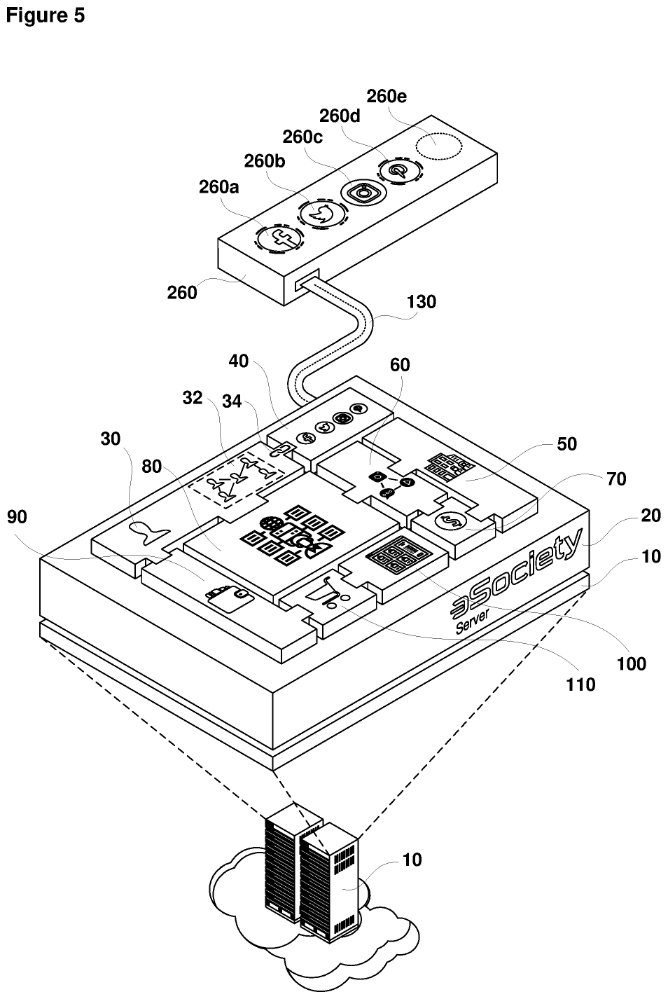

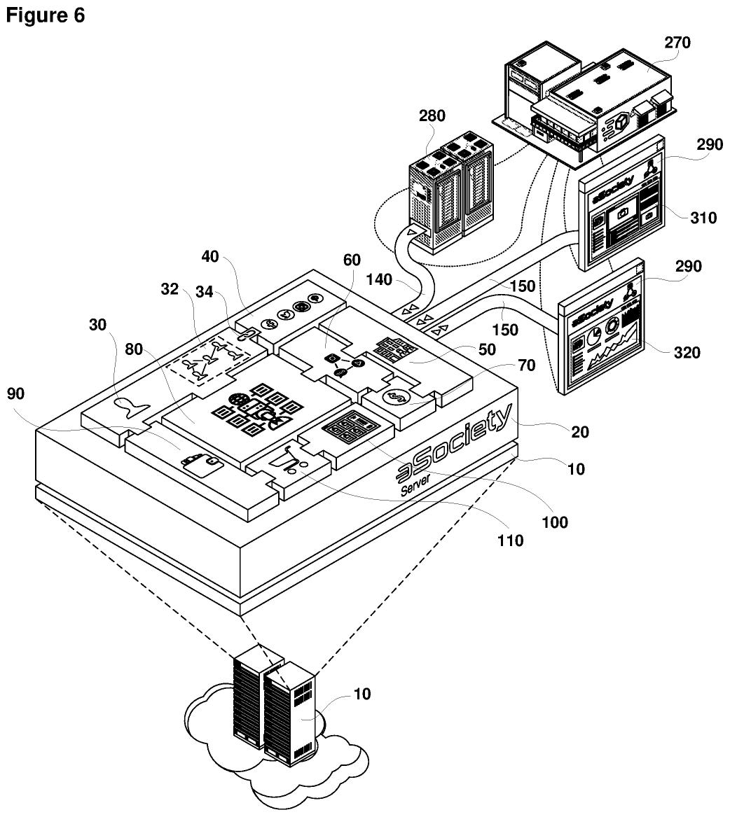

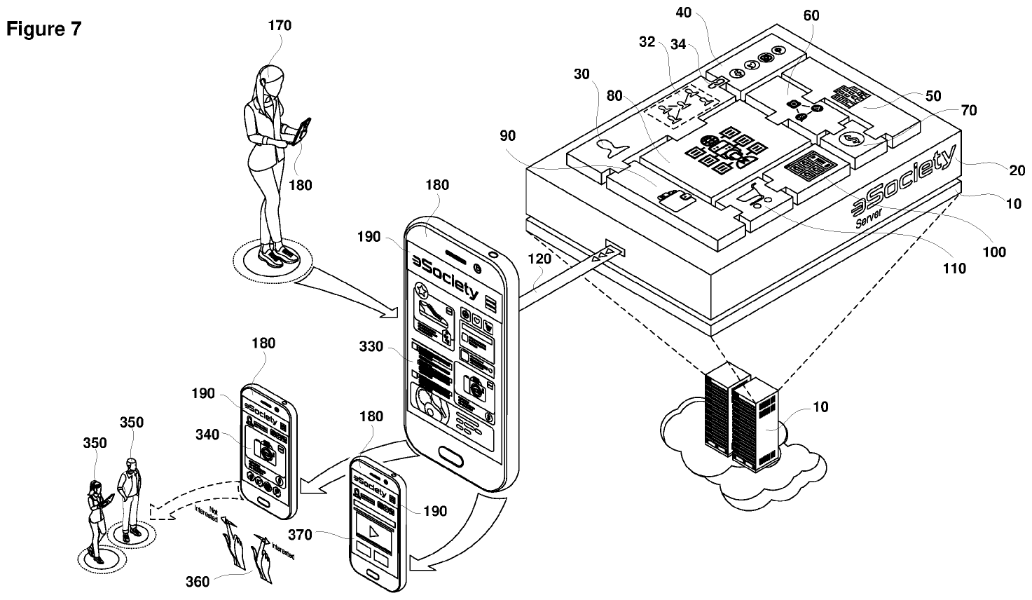

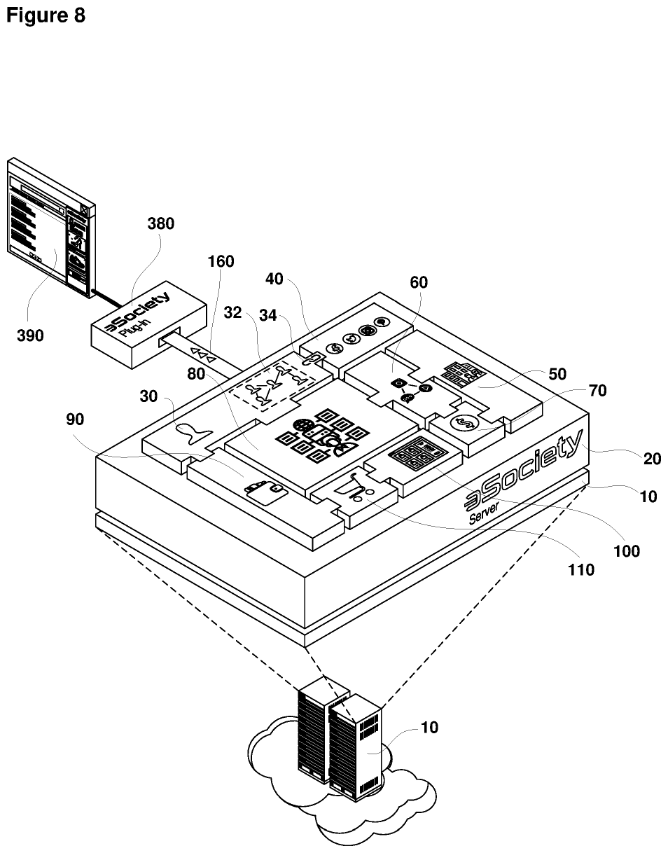

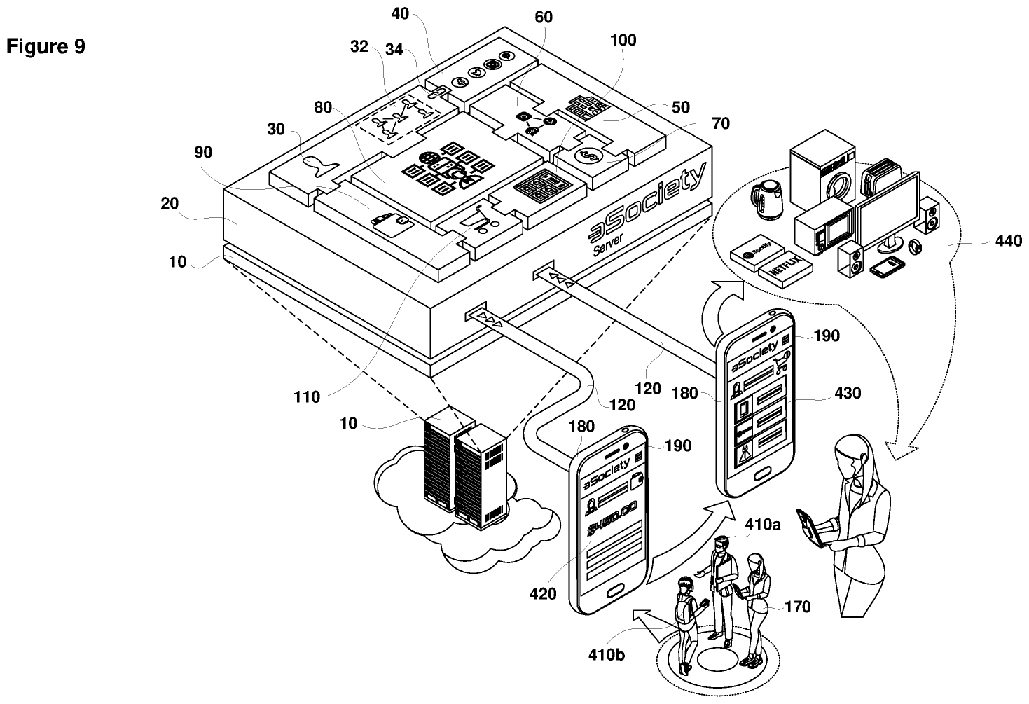

Segment 300 of FIG. 1 shows a potential recipient (170) downloading and installing the application (190, 210) and subsequently logging into the application (190, 210), which is expanded in FIG. 3. Segment 400 of FIG. 1 shows the recipient (170) uploading detailed information about themselves, which may include identification details (including biometric data) and profile data, and linking their social media accounts, which is expanded in FIG. 4. Segment 500 of FIG. 1 illustrates the server (20) interfacing with a range of social media platforms (260), as expanded in FIG. 5. Segment 600 of FIG. 1 shows an advertising company (270) as an example of a “requestor” interacting with the server (20), including uploading and retrieving data, which is expanded in FIG. 6. Segment 700 shows a similar interaction with the server (20), but from the perspective of the recipient (170), as expanded in FIG. 7. Segment 800 shows the use of a browser plug-in/extension (380) that may be associated with server (20), which is expanded in FIG. 8. Finally, segment 900 of FIG. 1 shows exemplary application interfaces (420, 430) which allows selected recipients (170) who have responded to view their reward information, such as credits, cash payments, and to redeem same in exchange for goods and/or services, which is expanded in FIG. 9.

As mentioned above, FIG. 2 shows the segment (200) from FIG. 1. In particular, FIG. 2 shows the server component (20) which includes infrastructure (10) upon which the platform of the present invention operates. The infrastructure (10) may be local or cloud-based. The central server (20) may operate one or more computer applications and maintain one or more databases that enable the following functionality and/or storage:
register (30) of user accounts relating to users, including for example potential recipients (170), the register storing identification details (including biometric information) and user profiles including key information about each user such as name, location, gender and date of birth;
register (32) of linked accounts, i.e. data relating to accounts in register (30) which are linked, such as members of the same household or users grouped on any other basis;
register (34) of linked social media accounts, i.e. data associated with social media accounts linked to particular user accounts (30). In this regard, users (170) are encouraged to link social media accounts since this will allow the application (190, 210) to crawl their social media in order to capture additional personal data (which may include identification details and profile data). Further, linking with social media enables the platform to post on a user's behalf which increases their opportunity to earn credits and allows users to share advertisements and other content with their friends and followers, as described in greater detail below;
functionality (40) to interface the server (20) with the range of social media platforms (260);
register (50) of requestor (270) accounts, e.g. requestor profiles including profiles of organisations (270) who have registered to advertise or provide additional content directly to customers and receive response data;
repository (60) which stores, temporarily or permanently, content that is provided by the requestors (50) such as advertisements and the like that are targeted to certain users (170). Such content may be static images and text, video or other media, and may seek opinions and feedback or may request users to engage with a particular brand (e.g. like, post, review or tip) on a social media platform or any other type of interface including a website;
register (70) of payments, e.g. fees paid by requestors (270) in exchange for the ability to use a requestor version of the application (290) to deliver content (60) to users (170);
repository (80) of user personal data including personal information such as demographic information, education levels, spending, relationships, current arrangements/contracts with companies (such as insurance, loans and mobile plans), religious affiliations and future plans. Potential recipients (170) will be encouraged to provide detailed personal information since the more detail provided by the potential recipients (170), the higher the prospect of such users being targeted and selected by advertisers and hence the greater the potential to earn credit;
register (90) of reward accounts, e.g. accounts relating to credit earned by each user (170) for responding to content (60) delivered by requestors (50), e.g. by viewing, reviewing, and/or interacting with content (60);
catalogue (100) of products and/or services such as goods for purchase, subscriptions, holidays and experiences that selected recipients (170) can purchase by redeeming credit; and
repository (110) of information relating to the purchase of particular products, services, subscriptions, etc. from the product and/or service catalogue (100) by a selected recipient (170) using their credits.

It is to be understood that despite there being multiple databases described above, including registers and repositories, this is by way of example only and it is to be understood that other arrangements are possible, e.g. all data could be stored in a suitably categorized data structure.

FIG. 2 also shows that the server (20) is configured to enable communication (120) with the software application (190, 210) operating on user devices (180) by use of a data communications network such as the internet, or similar network. Further, FIG. 2 shows that the server (20) is configured to interface (130) with social media platforms (260) (shown in FIG. 5), interface (140) with marketing systems (280) (shown in FIG. 6) associated with requestors (270) (shown in FIG. 6), and communicate (150) directly with requestors (270) using the internet or a similar data communications network. FIG. 2 also shows a communication line (160), described in more detail below with reference to FIG. 8, which enables communication between the server (20) and a browser plug-in/extension (380).

FIG. 3 shows user devices (180) operated by the potential recipient (170) to install the application (190, 210), which may be achieved by downloading the application from an Application store. The user (170) may create an account using the application (190, 210) and the account information may be stored in the user account register (30). The user account may capture information sufficient to enable the users to be correctly identified. Such information may include, for example, name, location, data of birth, gender and biometric information. The biometric information may include, but it not limited to, facial recognition data, fingerprints, finger and hand geometry recognition, iris recognition data and voice recognition data. The process of installing each of the applications is indicated by arrows (220), and an example interface which enables the user (170) to login or register to use the application is indicated by reference numeral (230). Whether using a mobile device or browser, users (170) will need to login using their login details or register as a new user and registration will require entry of basic user information such as name, location, gender and date of birth and any required biometric data. A subscription fee may also be applicable in relation to the use of application (190, 210).

Each requestor, such as advertiser organization (270), may download and register/login to requestor application (290).

FIG. 4 shows a potential recipient (170) providing detailed information about themselves using a personal detail interface (240), and linking, via social media interface (250), the user's social media accounts. Each of the interfaces (240) and (250) are generated by the software application (190) operating on the user device (180).

As mentioned previously, the greater the effort in relation to responding to requests from advertisers and the like, the more that users (selected recipients) (170) potentially have to gain by way of reward. It is for this reason that users (170) are encouraged to provide detailed information about themselves including demographic information, education levels, spending, relationships, etc. The non-identification details provided by users will assist advertisers and other requestors to target information to, and thereby select, particular users, and will thereby provide greater opportunity to earn credit. However, in order to ensure that users (recipients) are not identifiable, a database administrator (not shown), which as mentioned earlier may be an individual, company, or which may be computer-implemented, effectively acts as an intermediary between the recipients whose identification and profile data is stored by the server (20) whilst preventing the association between a recipient's identification details and their profile data from being publically available to outside entities.

Accordingly, the database administrator effectively becomes a trusted intermediary enabling external requestors such as advertisers (270) to obtain the benefit of accessing the profile data of a large number of potential recipients that meets the requestor's specific requirements, yet at the same time, preventing those external entities from identifying the recipients (170) with respect to whom the profile data is reviewed and/or analysed.

In the embodiment described above, the server (20) includes a user account register (30) as well as a user personal data repository (80), and it is to be understood that each of these databases may include a combination of identification details and profile data associated with each user. In order to identify and differentiate between such data, any suitable technique may be used including, for example, optical character recognition techniques which may involve the parsing of data to recognise certain terms, symbols, etc, that may be present and which are typically associated with an “identification detail” as opposed to “profile data”, or vice versa. In other words, such data may be present across a number of databases and the database administrator is tasked with identifying the different categories of data with a view to separating same and allowing access solely to “profile data” of recipients.

As previously described, when identifying users, a combination of different methods may be adopted. For example, biometric data, including facial recognition data, fingerprints, finger and hand geometry recognition, iris recognition data and voice recognition data may be adopted to identify users. Identification details and profile data may further include passwords, pin numbers, and various methods of identification including two-factor authentication and one-time-pin (OTP) may be used to ensure each user is correctly identified.

As mentioned above, users (170) may link their social media accounts, and this will be encouraged since it will allow the application (190, 210) to crawl the social media accounts and capture additional data relating to each user (170). In some circumstances, it will also allow the application (190, 210) to post on a user's behalf, which may increase the user's opportunity to earn credits, or at the very least will enable users to share content received from the requestors with friends and/or followers associated with the user (170). In this regard, FIG. 5 shows the server (20) interfacing with a range of social media platforms (260), including for example Facebook® (260A), Twitter® (260B), Instagram® (260C), Pinterest® (260D), and other social media sites (260E). By providing consent for the application (190, 210) to crawl the social media accounts, additional personal data may be collected for each user (170), which in turn, provides an additional means by which the user may earn credit.

The term “credit”, described in greater detail below, is to be understood that the earning of credits represents but one example of a “reward” that a user (170) may receive in exchange for responding to content delivered by a requestor (270).

FIG. 6 shows an example of a “requestor” in the form of an advertiser organisation (270), i.e. a company or organisation registered to use application (290) to advertise directly to users (170). The advertiser organisation (270) may include one or more digital marketing systems (280) which will facilitate interaction with the server (20) since it allows the advertiser organisation to automate their advertising activities and market research. The application (290) that is accessible by requestors is similar to the application (190, 210) used by users (170), but may be tailored to enable requestors to post content and attend to additional actions that are not necessarily required or available using the recipient-side application (190, 210).

An example interface (310) of application (290) is shown in FIG. 6 which provides functionality allowing the advertiser organisation (270) to create and post content such as advertisements to the platform. The advertiser organisation (270) may be requested to pay a fee for delivering such content, which fee may subsequently be stored and distributed to users (selected recipients) (170) who view and interact with the content as part of their “reward”. In exchange for paying a fee, the advertiser organisation (270) will receive profile data associated with the users, including response data, which enables the advertiser organisation to perform a variety of actions including to segment and target specific users (e.g. to get better value for their advertising spend).

Interface (320) is an example interface for reporting data to the advertiser organisation (270) to enable research and segmentation, and generally enable the organisation (270) to better understand their market and the impact of their advertising campaigns. For example, such data may be utilised to enable the advertiser (270) to remarket to users who have not previously shown interest in their content. For example, in the case of users who have not shown interest previously, remarketing may be initiated in an effort to change the users' minds or to create an advertising funnel.

The type of content that may be provided by the advertiser organisation (270), as well as examples of interactions between the user (170) and such content, is shown by way example in FIG. 7. In particular, FIG. 7 shows a user (170) receiving targeted advertising, and engaging with same in order to earn a reward in the form of credits.

A user engagement interface (330) is displayed to the user and provides the necessary functionality to enable the user (selected recipient) (170) to view the delivered content, which may be in the form of advertising, surveys, and/or other interactive content that is targeted to the user (170). The user (170) may be prompted to select particular content, such as selecting a particular product advertised, which may cause additional interfaces to be generated and displayed, such as interface (340) which provides specific detail with respect to a selected piece of content. In the example shown, the user (170) selects a product in the form of a camera and the generated additional interface (340) displays the camera and associated detail in an enlarged view and to the exclusion of other products. In addition to providing details regarding the particular product selected by the user (170).

The interface(s) may include links and other means of interaction to enable the user (170) to respond in additional ways, including to share content with friends, family or colleagues (350) or indicate their interest (360) in the content, e.g. like or dislike content by swiping left or right respectively. The recordal of such interactions can assist advertisers including improving future marketing campaigns. Where the content involves surveys or questionnaires, as shown in interface (370) for example, a user's response to such questions will equally enable the advertiser organisation (270) to utilise same for advertising, market research and other purposes.

The skilled addressee will appreciate the benefits of the present invention. A user (170) may be provided with content from an organisation, such as an advertisement or a questionnaire for completion or a requested action that requires completion, and the user (170) may provide their response to a database administrator who may forward same to the organisation (270) without the identification details of the user (170). In these circumstances, the database administrator may clearly identify those recipients who have provided a response to the content and then may proceed with allocating a reward to those recipients, or offering a discount with respect to purchase of the product.

The information and arrangement of information displayed may be different for each user, for example, the information and style of display may be tailored according to the user's profile and previous response(s) to content.

Advertisements and other content may be in the form of static images and text, video or similar content, and as described above, may be in the form of a questionnaire or survey that seeks opinion and feedback and request a user to engage with a particular brand on social media platforms such as liking or posting product reviews or tips. Users may be encouraged to like and share advertisements and other content that they are interested in to other users and across their social media platforms to increase the reach of content. The content reach may be one of the factors that is taken into account when the application calculates what portion of a reward offered by the advertiser should be allocated to the user (170) (e.g. how many credits to allocate to the user in exchange for their response efforts).

In one or more implementations, the database administrator responsible for separating data relating to a potential recipient's identification details from data relating to the profile of the potential recipient may also separate responses provided by the selected recipients from the identification details of the selected recipients such that providing the responses to the requestor (e.g. advertiser organisation (270)) does not provide any identification details regarding those recipients (170) who have provided the response. In this embodiment, the database administrator may readily identify those recipients (170) who have provided a response or performed an action, according to the requestor's information, and is therefore able to direct any acknowledgement or reward to those recipients who have provided a response or performed the requested action.

It is to be understood that external entities requesting a response from individuals may include organisations other than advertisers, such as associations or non-profit groups, and may even include individual persons or a collective of persons. The database administrator in their role as trusted intermediary may control the activities and/or actions of requestors such as limiting requests of individuals.

In an embodiment, the database administrator may also provide profile data of all the potential recipients (in respect of whom details are recorded in the database) to the external entity, such as the advertiser organisation (270) or some other organisation such as a data analysis agent (not shown) who seek to analyse the profile data of all recipients collectively, to determine the merits of either requesting information from the recipients (170) or transmitting offers to those recipients (170) for the purpose of obtaining interest in goods and/or services.

The provision of profile data may be ongoing such that those seeking to analyse such data have continuous access to the data. Conducting such an analysis may determine the commercial merit of initiating a campaign to transmit offers to recipients (170) or seek information from potential recipients (170) for whom details are stored in the register (30). This clearly provides an advantage to such external agencies seeking to identify with potential recipients (170) that fall within their “target market group”, and although the external agency is not provided with the direct identification details of potential recipients (170), by analysing the recipients profile data, they can determine whether a marketing campaign is warranted.

A further example of a requestor may be a market research organisation (not shown) seeking to understand the preference profile of consumers who purchase a particular good and/or service. In many instances, market research is conducted to better understand the preferences of consumers who already fall into a group of interest to the market research organisation.

Once an external agency has analysed the profile data of potential recipients and determined that a campaign to offer goods and/or services to those recipients, or seek information from those recipients, is warranted, the agency who conducted the profile analysis may provide the details of that analysis to the database administrator thereby enabling the database administrator to execute the same analysis. Of course, the external agency (270) conducts the analysis without the benefit of identification details in relation to those potential recipients (170) who have a relevant profile, whereas once the same analysis is conducted by the database administrator, the administrator has the benefit of obtaining the identification details of those potential recipients (170) relevant to the particular analysis. This particular arrangement also has the benefit of obtaining the most up to date details regarding recipients relevant to the analysis that seeks to identify those recipients with a relevant “profile of interests”.

There may also be circumstances in which it is expected that an agency conducting an analysis of profile data may complete the analysis and determine that an information campaign is warranted, although the database administrator may not receive instructions and/or payment from the agency until some time has passed. For example, the lapse of time between an agency conducting a profile analysis and instructing a database administrator to perform the same analysis to identify the relevant recipients (170) may be a period of one or two weeks or possibly one or two months. In that time, the database may have attracted many more potential recipients (170) to provide their details and hence, the database administrator repeating the analysis to identify relevant recipients will utilise the most up to date information regarding the recipients who have provided their details to the database administrator.

There may be various ways in which content from requestors, such as advertiser organisation (270), may be presented to the users (170). For example, such content need not necessarily be provided to those users (170) using application (190, 210). For example, the server (20) may utilise a browser plug-in/extension (380) as shown in FIG. 8 so that when a user (170) searches using their web browser, content may automatically be displayed to the user. The remarketing of advertising content to users in this manner is already known with respect to Google® and Facebook® remarketing, for example, in which users are targeted with advertising content according to their previous web browsing behaviour. In this instance, content which has been posted by a requestor, such as advertiser organisation (270), may subsequently be presented to users in a similar way, e.g. whilst the user utilises a search engine (390) such as Google® or Bing®, or whilst navigating social media sites such as Facebook® or Instagram®.

The types of rewards and the manner in which rewards may be allocated and displayed to each user (selected recipient) (170) is described in greater detail below with reference to FIG. 9.

As mentioned previously, users (selected recipients) (170) may earn credits for allocation to their account based upon the extent to which they respond to content, including for example the amount of content with which they interact and respond. The reward may include cash payments, reward points that have value according to the requestor's products/services, reward points that add value with entities other than the requestor, and/or a discount that may be applied to the purchase of goods and/or services at some time in the future from one or more entities.

FIG. 9 shows an example of interfaces (420) and (430) which respectively display credit balance accounts and the ability to redeem such credit in exchange for goods or services. Accordingly, users (170) can view their credits and use them to purchase products and services (440) such as electrical goods, subscriptions, holidays and experiences. Such products and services may be those made available from the requestors, such as the clients whom the advertiser organisation (270) represents, or from other external entities. Users may also be provided the option to redeem credit for gift cards or cash. Groups of users, such as households, or groups (410A, 410B) that have been formed on any other basis, may also pool their accounts to generate an increased credit in a shorter amount of time, which enables the users to redeem credit for products or services more quickly as compared with a single user accumulating credit.

In the event that a user (170) is interested in an advertisement for goods and/or services and prefers to purchase those goods and/or services, the user (170) may elect to act upon the offer separately and externally to the database administrator. When electing to purchase goods and/or services in this manner, it may remain unknown to the provider of the goods and/or services whether the particular user (170) has received the offer through the database administrator's services or through another mechanism. However, in a preferred embodiment, a consumer purchase arising from an advertisement/offer provided to a consumer through the services of the database administrator are identified to the provider of the goods or services thereby confirming the value of the database administrator's service. In one particular embodiment, selected recipients may pre-authorise the provision of their details when responding to offers of goods and/or services for those instances in which the recipient details are required. This particular embodiment is useful when a recipient prefers to accept an offer for insurance or finance which requires various details from the consumer. Where the consumer is a recipient according to the present invention, the pre-authorisation provided by the recipient to the database administrator enables the provision of the recipient's details whilst allowing the database administrator to remain consistent with their pledge to not release the details of recipients.

The determination of the reward allocated to any one user (selected recipient) for their particular response to requestor information may be based upon a number of different factors. According to an embodiment, the reward offered to users responding to a requestor's content varies according to the time in which the recipient provides a response to the information, or the time and effort associated with responding to a particular request. For example, in the event a selected recipient provides a prompt response, the reward may have a greater value as compared with a response that is provided two or three days later or potentially two or three weeks after the selected recipient receives the requestor's information. In this embodiment, selected recipients receive a greater reward for a prompt response as compared with a delayed response or a greater reward according to the time/effort involved.

Rewards may be provided according to the perceived effort on the part of the selected recipient providing the response. In this regard, the greater the effort required, the greater the reward. For example, if a selected recipient devotes effort to share the content widely across a significant number of additional users, they may be rewarded accordingly. The reward selected may also be relevant to the target demographic of interest to the requestor which provides a specific, and potentially greater, motivation to users with a matching profile to respond to the request by providing the information sought, or performing the action required.

The user device (180) could be a tablet computer, a smartphone, a laptop computer, a desktop computer, or another type of computing device. The user device may include a display that provides an interface for the user to input and/or view information. For example, a user could interact with the device using a program executed on a laptop computer, such as a text-based chat program, a voice-based communication program, and/or a video-based communication program. Alternatively, in some cases, the user device (180) could be a telephone (e.g., a landline, cell phone, etc.).

The central server (20) may be a single computer, the partial computing resources of a single computer, a plurality of computers communicating with one another, or a network of remote servers (e.g., cloud). The one or more servers can house local databases and/or communicate with one or more external databases.

The user device (180) may communicate with the server (20) over a network. In some embodiments, the network may be a wide area network (“WAN”), e.g., the Internet. In other embodiments, the network may be a local area network (“LAN”). For example, in a more remote location far from a metropolitan area, the Internet may not be available. In yet other embodiments, the network may be a combination of a WAN and a LAN. In embodiments where the user device (180) is a phone (e.g., a landline or a cell phone), the communication may pass through a telecommunications network and/or a wide area network.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A method of rewarding recipients for the resources devoted to reviewing and/or responding to a requestor's data, the method including the steps of:
a database administrator administering a database of data pertaining to potential recipients including data relating to identification details and one or more profiles of the potential recipients;
the database administrator separating the data relating to identification details from the profile data of the potential recipients thereby generating anonymised profile data for each potential recipient, separate from identification details and preventing potential recipients accessing the anonymised profile data;
enabling access to profile data of potential recipients in accordance with a request thereby enabling the requestor to analyse the profile data of potential recipients but without access to any identification details of corresponding potential recipients;
receiving a request to transmit the requestor's data to one or more potential recipients relevant to a data query resulting from an analysis of the profile data; and
the database administrator transmitting the requestor's data to recipients who satisfy the analysis profile for and on behalf of the requestor, the requestor's data requiring a response from recipients satisfying the analysis profile whereby recipients providing a response receive a reward, the database administrator providing responses to the requestor without provision of any identification details regarding the recipients.

2. (canceled)

3. A method according to claim 1, wherein the database administrator is an individual, a company, or is computer-implemented.

4. A method according to claim 1, wherein the data relating to identification details of potential recipients is separated from the profile data of those recipients using optical character recognition.

5. A method according to claim 1, wherein the identification details include biometric data including any one or more of facial recognition data, fingerprint data, finger and hand geometry recognition data, iris recognition data or voice recognition data.

6. A method according to claim 1, wherein the response includes any one or more of viewing an article, viewing an advertisement, viewing a feature length movie or performing an action.

7. A method according to claim 6, wherein performing the action includes any one or more of provision of information, completion of a survey, completion of a questionnaire or completion of an action sought by the requestor.

8. A method according to claim 1, wherein the requestor's data is automatically displayed to the selected recipients satisfying the analysis profile whereas those recipients use a web browser to search the internet.

9. (canceled)

10. A method according to claim 8, wherein the provision of the profile data to the one or more external agencies is on-going such that the one or more external agencies have continuous access to the profile data of potential recipients.

11. A method according to claim 1, wherein the reward includes any one or more of cash payments, reward points having value according to the database administrator's services, reward points having value with entities other than the database administrator, a discount that may be applied to the future purchase of goods or services by recipients.

12. A method according to claim 1, wherein the reward offered to recipients varies according to the time taken for the recipient to respond to the requestor's data.

13. A method according to claim 1, wherein the reward offered to recipients varies according to the effort associated with responding to the requestor's data.

14. A system that rewards recipients for the resources devoted to reviewing and/or responding to a requestor's data, the system including:
one or more databases pertaining to potential recipients including data relating to identification details and one or more profiles of the potential recipients, and
one or more processors, communicatively coupled to the one or more databases, that:
are operable to enable a database administrator to:
administer the one or more databases, and
separate the data relating to identification details from the profile data of the potential recipients thereby generating anonymised profile data for each potential recipient separate from identification details and preventing potential recipients accessing the anonymised profile data;
enable access to profile data of potential recipients in accordance with a require thereby enabling the requestor to analyse the profile data but without access to corresponding identification details of potential recipients;
receive a request to transmit the requestor's data to one or more of the potential recipients relevant to a data query resulting from an analysis of the profile data; and
the one or more processors further operable to enable the database administrator to transmit the requestor's data to recipients who satisfy the requestor's profile analysis for and on behalf of the requestor, the requestor's data requiring a response from the recipients satisfying the analysis profile whereby recipients providing a response receive a reward, the database administrator causing the responses to be provided to the requestor without provision of identification details regarding recipients.

15. A system according to claim 14, wherein the recipients respond to the requestor's data by a user device associated with each of the recipients, and wherein the interfaces include links to additional interfaces or internet material.

16. A system according to claim 14, wherein the database administrator is an individual, a company, or is computer-implemented.

17. (canceled)

18. A system according to claim 14, wherein the identification details include biometric data including any one or more of facial recognition data, fingerprint data, finger and hand geometry recognition data, iris recognition data and voice recognition data.

19. A system according to claim 14, wherein the response includes any one or more of viewing an article, viewing an advertisement, viewing a feature length movie or performing an action.

20. A system according to claim 19, wherein performing the action includes any one or more of provision of information, completion of a survey, completion of a questionnaire or completion of an action sought by the requestor.

21. A system according to claim 14, wherein the requestor's data is automatically displayed to recipients satisfying the analysis profile where the recipients use a web browser to search the internet.

22. A system according to claim 14, wherein the database administrator provides profile data of all of the potential recipients for whom details are recorded in the database to one or more external agencies.

23. A system according to claim 22, wherein the provision of the profile data to the one or more external agencies is on-going such that the one or more external agencies have continuous access to the profile data of potential recipients.

24. (canceled)

25. A system according to claim 14, wherein the reward offered to recipients varies according to the time taken for recipients to respond to the requestor's data.

26. A system according to claim 14, wherein the reward offered to recipient varies according to the effort associated with responding to the requestor's data.

27. A computer-readable medium storing computer instruction code to reward recipients for the resources devoted to reviewing and/or responding to a requestor's data, the instructions including one or more instructions that, when executed by one or more processors, cause the one or more processors to:
enable a database administrator to administer a database of data pertaining to potential recipients including data relating to identification details and one or more profiles of the potential recipients;
enable the database administrator to separate the data relating to identification details of the potential recipients from the profile data of those recipients thereby generating anonymised profile data for each potential recipient separate from identification details and preventing potential recipients accessing the anonymised profile data;
enable access to profile data of recipients in accordance with a request thereby enabling the requestor to analyse the profile data of potential recipients but without access to corresponding identification details of the recipients;
receive a request to transmit the requestor's data to the one or more potential recipients relevant to a data query resulting from an analysis of the profile data; and
enable the database administrator to transmit the requestor's data to recipients who satisfy the requestor's profile analysis for and on behalf of the requestor, the requestor's data requiring a response from the recipients satisfying the analysis profile whereby those recipients providing a response receive a reward for providing the response, the database administrator providing recipient responses to the requestor without provision of any identification details regarding the recipients.

28. A method according to claim 1, wherein the recipients respond to the requestor's data by a user device associated with each of those recipients, and wherein the interfaces include links to additional interfaces or internet material.

29. A method according to claim 1, wherein the database administrator provides profile data of all potential recipients for whom details are recorded in the database to one more external agencies.

30. A system according to claim 14, wherein the data relating to identification details of the potential recipients is separated from the profile data of those recipients using optical character recognition.

31. A system according to claim 14, wherein the reward includes any one or more of cash payments, reward points having value according to the database administrator's services, reward points having value with entities other than the database administrator, and/or a discount that may be applied to the future purchase of goods and/or services by the recipients.
